(19) United States
(12) Patent Application Publication
(10) Pub. No.: US 2020/0372557 A1
(43) Pub. Date: Nov. 26, 2020

(54) Systems and Methods to Determine Regulatory and Business Logic Classifications Based on First Principles

(71) Applicant: Waste Repurposing International, Inc., Austin, TX (US)

(72) Inventors: Evan Peters, San Diego, CA (US); Charlie Vallely, Austin, TX (US); Jason Melbourne, Los Angeles, CA (US)

(73) Assignee: Waste Repurposing International, Inc., Austin, TX (US)

(21) Appl. No.: 16/557,979

(22) Filed: Aug. 30, 2019

Related U.S. Application Data
(60) Provisional application No. 62/851,123, filed on May 22, 2019.

(51) Int. Cl. G06Q 30/06; G06Q 10/00; G06Q 10/08

(52) U.S. Cl. CPC G06Q 30/0607; G06Q 10/0832; G06Q 10/30

(57) ABSTRACT

A system may receive product information associated with a product and may automatically determine regulatory classifications and business logic classifications for the product based on the product information. The system may determine fundamental attributes of a product based on received product information by searching one or more data sources. The fundamental attributes may include chemical composition data. The system may apply a plurality of logic classifications to the product information and the fundamental attributes to determine regulatory classifications and business logic classifications for the product. The system may provide an output including one or more of the product information, the regulatory classifications, and the business logic classifications. In one implementation, the system may retrieve a safety data sheet (SDS) and compare the determined values to values of the SDS to detect errors in the SDS. In another implementation, the system may automatically generate the SDS based on the determined values.

### FIELD

The present disclosure is a non-provisional of and claims priority to co-pending U.S. Provisional Patent Application No. 62/851,123 filed on May 22, 2019 and entitled “Systems and Methods of Automated Hazard Calculations for Waste and Transportation,” which is incorporated herein by reference in its entirety.

### FIELD

The present disclosure is generally related to systems, methods, and devices for automatic determination of regulatory or business logic classifications of a product based on input data, reference data, and first principles. The first principles may include regulatory and business logic classifications that may be determined based upon the fundamental attributes of a product using logical expressions, lookup tables, calculations, and synthetic intelligence (e.g., machine learning). Some examples of fundamental attributes may include chemical properties; intended use; packaging type and dimensions; physical properties, and so on. Further, the present disclosure is generally related to systems, methods, and devices that may utilize the regulatory or business logic classifications for the purposes of determining rules or guidelines for transportation of a product by land, air, or sea; disposal of a product; recycling of a product; donation of a product to a charity (i.e. reuse); emergency response to an incident involving a product; returning a product to vendor; packaging of a product; labeling of a product, or any combination thereof.

### BACKGROUND

Government agencies are tasked with promulgating safety regulations for keeping our roads, waterways, and airways safe and for maintaining our environment. In the United States, the Department of Transportation regulates the transportation of household hazardous waste products by land, sea, and air. Additionally, state and local governments may also issue regulations related transportation of such products.

Further, the Environmental Protection Agency regulates the disposal of household hazardous waste products. In some instances, state governments, county agencies, and local governments may also impose regulations on the disposal of household hazardous waste products.

For example, certain types of products, such as chemical products, paint products, and other products (including those that cannot be identified), may sometimes be classified as hazardous. Transportation regulations may determine costs, packaging, and other parameters for transporting such products. It should be appreciated that such regulations may vary based on the packing, the quantity, and so on.

Further, once classified as hazardous, such products must be handled carefully and disposal of such products may be determined according to various regulations. For example, laundry detergent, bleach, cleaning products, paints, aerosols, and other products may be sufficiently safe that such products may be placed on store shelves, may be sold to consumers without a special permit or license, and may be transported in a standard automobile. However, such items may not be discarded in a landfill. Rather, such items must be disposed of according to hazardous waste codes and associated environmental regulations.

### SUMMARY

Embodiments of systems, methods, and devices are described below that may receive product information, such as a product name, a barcode, a universal product code (UPC), a safety data sheet (SDS), other information, or any combination thereof from one or more sources, such as a user device, another computing system, and so on. The system may retrieve data related to the received product information from one or more information sources. The information sources may users, computing devices, websites, databases, other sources, or any combination thereof. The system may extract data from the received product information and the retrieved data, process the extracted data to identify categories of information, and populate a temporary table with the extracted information organized according to the identified categories.

The system may automatically determine regulatory and business logic classifications for a product based on the product information in the temporary table. The system may include a first principles module configured to analyze the product information using logical expressions, lookup tables, calculations, and synthetic intelligence (e.g., machine learning) that may be made based upon the fundamental attributes of a product. Some examples of fundamental attributes may include chemical properties; intended use; packaging type and dimensions; physical properties, and so on. Further, the system may utilize the regulatory or business logic classifications to determine rules or guidelines for transportation of a product by land, air, or sea; disposal of a product; recycling of a product; donation of a product to a charity (i.e. reuse); emergency response to an incident involving a product; returning a product to vendor; packaging of a product; labeling of a product, or any combination thereof.

In some implementations, the system may utilize a first principles module to process fundamental attributes of a product using one or more algorithms, which may include logical expressions (e.g., Boolean logic), lookup operations, calculations, synthetic intelligence, or any combination thereof to determine regulatory and business logic classifications for a product. The fundamental attributes may include chemical properties; intended use; packaging type and dimensions; physical properties, and so on. Further, the system may utilize the regulatory or business logic classifications to determine rules or guidelines for transportation of a product by land, air, or sea; disposal of a product; recycling of a product; donation of a product to a charity (i.e. reuse); emergency response to an incident involving a product; returning a product to vendor; packaging of a product; labeling of a product, or any combination thereof. The system may use the regulatory classifications and the fundamental attributes to determine chemical composition data, hazard classification data, packaging group data, packing group data, United Nations (UN) Number data, proper shipping name data, state toxic codes, globally harmonized system (GHS) labeling data, Resource Conservation and Recovery Act (RCRA) code data, transportation data for the transportation of the product on land, on the seas, and in the air based on transportation regulations, other information, or any combination thereof. . Further, the system may communicate at least a portion of the product data to a computing device.

The systems, methods, and devices may be used by manufacturers to determine packaging information, such as quantities, volumes, and other information for product packaging and marketing purposes. In an example, an aerosol product may be classified as flammable and hazardous at certain quantities, while lesser quantities may be deemed non-hazardous for the purpose of transportation regulations. For example, an eight-ounce aerosol may be deemed non-hazardous, while a sixteen-ounce aerosol may be deemed hazardous according to the transportation regulations. If the eight-ounce aerosol were packaged with another eight-ounce aerosol may in a two-pack, the resulting product may be deemed hazardous, which may increase the cost of transportation. The manufacturer or wholesaler may utilize the system to validate marketing decisions to avoid expenses that might undermine profitability. Other implementations are also possible.

In some implementations, the systems, methods, and devices may be used to validate safety data sheet (SDS) information. In an example, the system may receive an SDS for a product. The system may parse the SDS to extract the information, categorize the information, and populate a table with the information. The system may also retrieve additional information associated with the product from one or more data sources. The system may utilize the first principles module to determine regulatory and business logic classifications for a product. The system may then compare the calculated information to information in the SDS. In an example, an SDS may include a hazard classification indicative of high corrosivity based on one or more chemical components within the product composition. However, the product composition may include a large quantity of water, diluting the chemical component to a level that the product does not need to be classified as corrosive according to governmental regulations. In this example, the system may flag the SDS information as being possibly incorrect. Alternatively, the system may generate a corrected SDS with updated hazard classification information. In some implementations, the system may receive multiple SDS documents. The system may automatically resolve ambiguity in favor of a most recent version of the SDS documents. Subsequently, the product information may be analyzed and the SDS data may be determined by the system, automatically. Other implementations are also possible.

In other embodiments, a system may include an interface to receive product information from a communication network, a processor coupled to the interface, and a memory to store data and to store processor-readable instructions. The processor-readable instructions may cause the processor to receive the product information associated with a product and automatically process the product information to determine regulatory and business logic classifications for a product. The processor-readable instructions may also cause the processor to utilize the regulatory classifications and the business logic classifications to automatically determine rules or guidelines for transportation of a product by land, air, or sea; disposal of a product; recycling of a product; donation of a product to a charity (i.e. reuse); emergency response to an incident involving a product; returning a product to vendor; packaging of a product; labeling of a product, or any combination thereof. In some implementations, the system may apply one or more logical expressions (e.g., Boolean logic), lookup operations, calculations, synthetic intelligence, or any combination thereof to determine transportation classification data, hazard classification data, packing group data, United Nations Number data, proper shipping name data, state toxic codes, globally harmonized system (GHS) labeling data, Resource Conservation and Recovery Act (RCRA) code data, other data, or any combination thereof.

The system may include a communications interface, a processor coupled to the communications interface, and a memory to store data and to store processor-readable instructions. The processor-readable instructions may cause the processor to receive product information associated with a product and determine fundamental attribute data for the product based on the product information and optionally based on information retrieved from one or more data sources. The fundamental attribute data may include chemical properties; intended use; packaging type and dimensions; physical properties, and so on. The processor-readable instructions may also cause the processor to determine regulatory classifications and business logic classifications for the product based on the fundamental attribute data, and provide an output including data related to the regulatory and business logic classifications.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 depicts a flow diagram of a method of automatically determining regulatory and business logic classifications based on first principles, in accordance with certain embodiments of the present disclosure.

FIG. 2 depicts a block diagram of a system including a classification system to automatically determine regulatory and business logic classifications based on first principles, in accordance with certain embodiments of the present disclosure.

FIG. 3 depicts a block diagram of a system including a classification system to automatically determine regulatory and business logic classifications based on first principles, in accordance with certain embodiments of the present disclosure.

FIG. 4 depicts a block diagram of a system including a classification system, in accordance with certain embodiments of the present disclosure.

FIG. 5 depicts a block diagram of a system including the classification system of FIGS. 1-4, in accordance with certain embodiments of the present disclosure.

FIG. 6 depicts a block diagram of the classification system that may be used with the methods and systems of FIGS. 1-4.

FIG. 7 depicts a diagram of a computing device that may be used in conjunction with the methods and systems of FIGS. 1-6, in accordance with certain embodiments of the present disclosure.

FIG. 8 depicts a diagram of a method of automatically determining regulatory and business logic classifications based on first principles, in accordance with certain embodiments of the present disclosure.

FIG. 9 depicts a diagram of a method of automatically producing a safety data sheet for a product, in accordance with certain embodiments of the present disclosure.

FIG. 10 depicts a diagram of a method of providing regulatory and business logic classifications based on first principles, in accordance with certain embodiments of the present disclosure.

While implementations are described in this disclosure by way of example, those skilled in the art will recognize that the implementations are not limited to the examples or figures described. It should be understood that the figures and detailed description thereto are not intended to limit implementations to the particular form disclosed but, on the contrary, the intention is to cover all modifications, equivalents, and alternatives falling within the spirit and scope as defined by the appended claims. The headings used in this disclosure are for organizational purposes only and are not meant to be used to limit the scope of the description or the claims. As used throughout this application, the word “may” is used in a permissive sense (i.e., meaning having the potential to) rather than the mandatory sense (i.e., meaning must). Similarly, the words “include”, “including”, and “includes” mean “including, but not limited to”.

### DETAILED DESCRIPTION OF ILLUSTRATIVE EMBODIMENTS

In the following detailed description of embodiments, reference is made to the accompanying drawings which form a part hereof, and which are shown by way of illustrations. It is to be understood that features of various described embodiments may be combined, other embodiments may be utilized, and structural changes may be made without departing from the scope of the present disclosure. It is also to be understood that features of the various embodiments and examples herein may be combined, exchanged, or removed without departing from the scope of the present disclosure.

In accordance with various embodiments, the methods and functions described herein may be implemented as one or more software programs running on a computer processor or controller. For example, the methods and functions described herein may be implemented as one or more software programs running on a computing device, such as a tablet computer, smartphone, personal computer, server, or any other computing device. In one possible example, the methods and functions described herein may be implemented on a sorting device used to sort products for transportation, disposal, or both. Dedicated hardware implementations including, but not limited to, application specific integrated circuits, programmable logic arrays, and other hardware devices may likewise be constructed to implement the methods and functions described herein. Further, the methods described herein may be implemented as a device, such as a computer readable storage medium or memory device, including instructions that when executed cause a processor to perform the methods.

Embodiments of systems, methods, and devices are described below that may include a classification system configured to receive product information associated with an unsaleable product, such as a product with damaged packaging, a returned product, a waste item, and so on. The classification system may be configured to process the product information to extract attributes associated with the product and optionally to use the product information and the extracted attributes to retrieve data associated with the unsaleable product. The system may use the information to determine regulatory classifications and business logic classifications based on first principles. For example, the system may automatically determine regulatory classifications corresponding to United State Department of Transportation laws and regulations for a product based on the product information. The system may include a first principles module configured to analyze the product information using logical expressions, lookup tables, calculations, and synthetic intelligence (e.g., machine learning) that may be made based upon the fundamental attributes of a product. Some examples of fundamental attributes may include chemical properties; intended use; packaging type and dimensions; physical properties, and so on. Further, the system may utilize the regulatory or business logic classifications to determine rules or guidelines for transportation of a product by land, air, or sea; disposal of a product; recycling of a product; donation of a product to a charity (i.e. reuse); emergency response to an incident involving a product; returning a product to vendor; packaging of a product; labeling of a product, or any combination thereof

If the determined regulatory classifications and the business logic classifications are sufficiently reliable or if the classifications are reviewed and approved by an authorized user, the system may utilize the regulatory classifications and the business logic classifications to determine recommendations for a task. Further, the determined data may be stored in a data record for the unsaleable product. Additionally, in some instances, at least a portion of the determined data may be provided to a computing device associated with a user. For example, the system may communicate an interface to a computing device, where the interface may include regulatory classification data, business logic classifications, a client task, a recommendation, other data, or any combination thereof. Other implementations are also possible.

In some implementations, the system may utilize the determined regulatory classifications to evaluate a safety data sheet (SDS) supplied by the manufacturer. If there are discrepancies between the SDS and the determined regulatory classifications, the system may identify the discrepancies and may communicate an alert to one or more other devices. In one possible example, the discrepancies may exist between an attribute within the SDS and a corresponding regulatory classification or fundamental attribute. For example, an SDS may indicate that the product is corrosive, but the determined regulatory classifications or fundamental attributes may specify that the corrosive component of the composition is diluted to a level that renders the composition non-corrosive. Accordingly, the SDS may have an error. In some implementations, the system may generate an alert to an expert user to review the determined regulatory classifications or fundamental attributes relative to the SDS. Other discrepancies and other implementations are also possible.

Embodiments of the present disclosure may operate to eliminate the mistakes by eliminating employee guesswork from the decision-making process. In one example, the system may be configured to automatically generate an SDS based on one or more of product information, fundamental attributes of the product, regulatory classifications, and business logic classifications. In some implementations, the system may utilize fundamental chemical principles to calculate the various chemical attributes, and which may be used to detect errors in an existing SDS, or which may be used to generate the regulatory classifications and other chemical attributes for inclusion in an SDS. This automated generation of the SDS may reduce or eliminate human errors or guesswork in the SDS generation process.

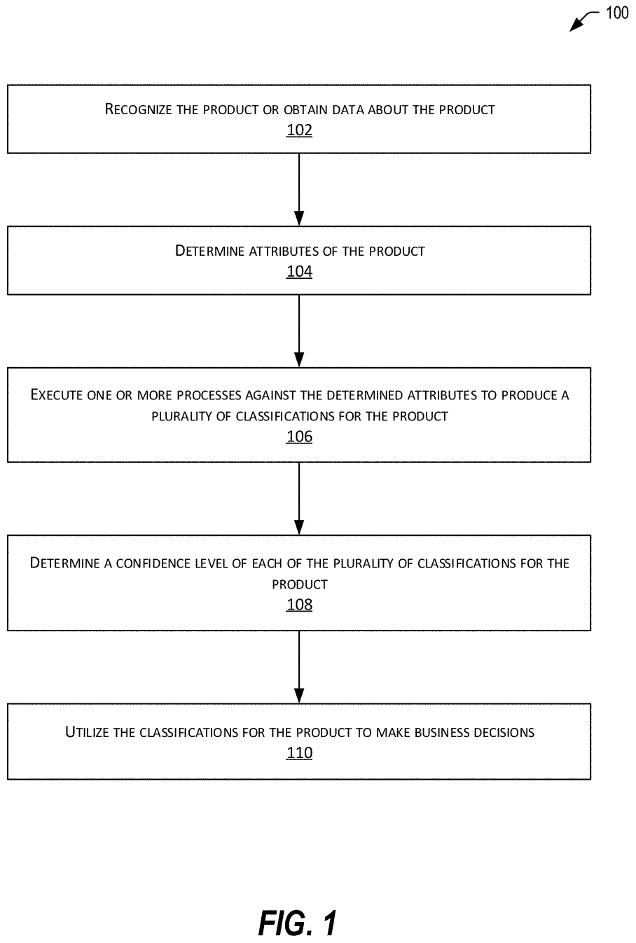

In another example, the system may operate to eliminate mistakes by eliminating employee guesswork from the decision-making process with respect to donation, reuse, or disposal of a product. The system may determine the regulatory classifications and the business logic classifications using a plurality of logic expressions. The business logic classifications may specify one or more tasks, options, or recommendations for handling and disposal of the product by an employee of the client. The business logic classifications may be defined by a company and may be unique to a retail location relative to another retail location within the same company. One example of a method of determining regulatory and business logic classifications for a product is described below with respect to FIG. 1.

FIG. 1 depicts a flow diagram 100 of a method of automatically determining regulatory and business logic classifications based on first principles, in accordance with certain embodiments of the present disclosure. In general, the products may include retail products, unsaleable products, waste products, spoilage, or other types of items. other items, or any combination thereof. Unsaleable products may include products with damaged packaging or products with torn shrink wrap or other issues that render such products unsaleable in a retail store, but with might otherwise be usable.

At 102, the system recognizes the product or obtains data about the product. In one possible example, a user may enter information at a keyboard, scan a barcode, capture images, or otherwise enter information about the product using a computing device and may provide the information to the system. In one possible example, the system may receive data, such as text data, a universal product code (UPC), a photograph of the product, or any combination thereof. The system may process the received data to extract information, which may be used to determine product information by searching one or more data sources including a database of products. For example, the system may extract information received from a submitted a web form and may search one or more data sources based on the submitted data to determine the product information.

At 104, attributes of the product are determined. The attributes may include chemical properties, intended use, packaging type and dimensions, physical properties, other information, or any combination thereof. The system may use the extracted information to retrieve data about the product, including attributes. When the system is unable to locate data about the product in the database, the system may launch an automated, real-time search for the product. In some implementations, the system may launch web crawler applications and interact with one or more search engines based on the extracted information to identify the product, to obtain data about the product, or any combination thereof. If this automated search fails, the UPC data, the photograph, or any combination thereof may be sent to a computing device associated with a user, who may then search for information about the product.

The attributes of the product may include fundamental attributes, such as the chemical makeup, laboratory test data, intended usage data, other data, or any combination thereof. These fundamental attributes may often be found on a product's safety data sheet (SDS), or by searching the Internet. For example, product information including fundamental attributes may be available from the manufacturer's website, an online database of products, a retailer's website, or any combination thereof. Once these fundamental attributes are determined, the attributes may be parsed and normalized for analysis in an algorithmic process.

At 106, the system may execute one or more processes against the determined attributes to produce a plurality of classifications for the product. In order to determine how the product is classified per governmental regulations or a client's business rules, an extensive series of algorithms may be automatically applied to the attributes. In some implementations, the system may determine regulatory and business logic classifications based on logical expressions (such as Boolean logic expressions), lookup tables, calculations, and synthetic intelligence (e.g., machine learning). The output of the series of algorithms includes a set of “First Principle” classifications. The regulatory classifications may pertain rules or guidelines for transportation of a product by land, air, or sea according to United States Department of Transportation regulations and optionally other transportation regulations, disposal of a product according to United States Environmental Protection Agency regulations and optionally other disposal rules and regulations; and so on. The business logic classifications may pertain to rules or guidelines for handling of a product by a retail employee, such as company rules for recycling of a product, donation of a product to a charity (i.e. reuse), emergency response to an incident involving a product, returning a product to vendor, packaging of a product, labeling of a product, or any combination thereof.

At 108, the system determines a confidence level for each of the plurality of classifications. For example, the first principle classifications may be automatically subjected to an analysis of their respective confidence levels. In this analysis, algorithms, including synthetic intelligence algorithms (fuzzy logic, machine learning, neural networks, and so on), may be applied to assign a relative confidence score to each classification that has been generated. For example, confidence values may be determined within a range of 0 to 1, representing a percentage confidence or reliability. If a classification falls below a threshold score that is determined to be acceptable, this classification will not be utilized in making client-facing recommendations.

At 110, the classifications for the product are utilized to make business decisions. Once a product has been classified, these classifications are then run through another set of automated algorithms that address the specific task that the client is wishing to accomplish. The output of these algorithms may provide automated, optimized recommendations to the client. Some examples of specific client tasks for products may include, but are not limited to, transportation of the product by land, air, or sea; disposal of the product; recycling of the product; donation of the product to a charity (i.e. reuse); emergency response to an incident involving the product; return or the product to the vendor; packaging; labeling; other information; or any combination thereof.

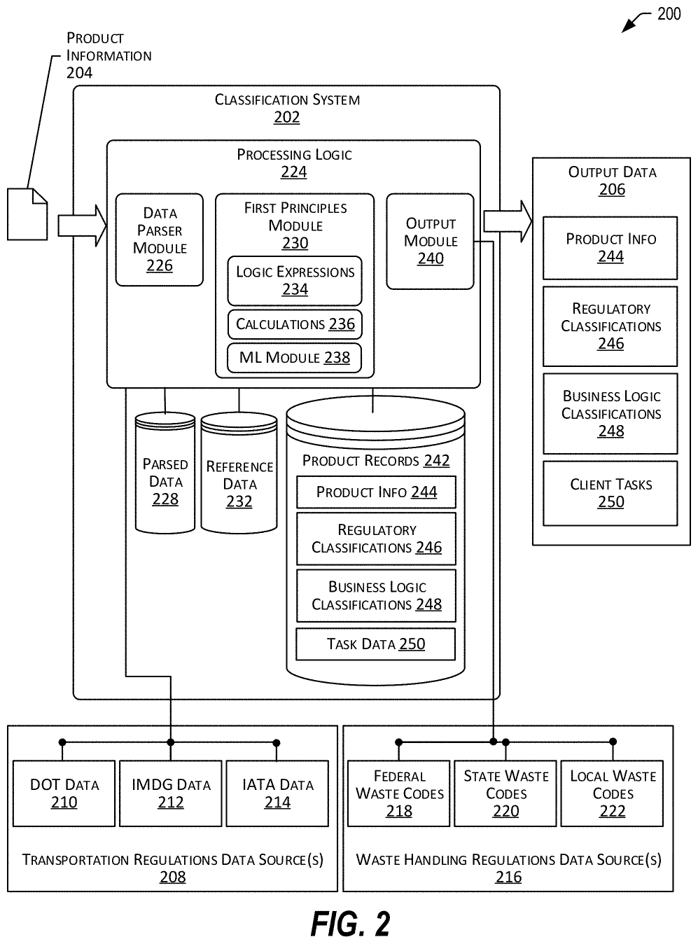

The method described above with respect to FIG. 1 may be performed by a computing system configured to communicate with one or more computing devices through a network, such as the Internet. Further, the system may provide business decision data based on the regulatory classifications as well as information specific to an enterprise, such as business logic classifications including rules or guidelines for the business with respect to products having certain regulatory classifications. One possible example of such a system is described below with respect to FIG. 2.

FIG. 2 depicts a block diagram of a system 200 including a classification system 202 to automatically determine regulatory and business logic classifications, in accordance with certain embodiments of the present disclosure. In the illustrated example, the classification system 202 may receive product information 204 and generate output data 206 based on the product information 204. The output data 206 may include product information 244 including the received product information 204 and information determined about the product. The information about the product may include fundamental attributes including chemical properties, intended use, packaging type and dimensions, physical properties, and so on. In some implementations, the output data 206 may include regulatory classifications 246, including a collection of classifications for the product that are generated per the rules of governmental, environmental, and transportation regulatory agencies. Examples of such classifications may include federal waste codes, state waste codes, United Nations (UN) numbers, hazard classes, packaging groups, proper shipping names, limited quantity exceptions, other information, or any combination thereof. In an example, the regulatory classifications 246 may also include chemical composition data, chemical reactivity data, chemical corrosivity data, chemical toxicity data, flammability data, hazard data, transportation data, other data, or any combination thereof. In some implementations, the product data may also include a barcode, a universal product code (UPC), hazard class data, packing group data, United Nations (UN) numbers, proper shipping names (PSNs), other data, or any combination thereof.

The output data 206 may also include business logic classifications 248, which may be determined from the regulatory classifications 246 and from rules specified by a company. The rules specified by the company may specify guidelines and procedures that are particular to the company. The regulatory classifications 246 may include rules that are specific to a retail location and may include different rules for another retail location. For example, the business logic classifications 246 may include rules or guidelines for disposal of a product. For a first product, the rules or guidelines may indicate that the product may be recycled, reused at the retail location, or donated to a third-party. For a second product, the rules or guidelines may indicate that the product must be disposed of according to the regulatory classifications. The business logic classifications 246 may allow for donation of a product to a charity, reuse of the product by an employee at the retail location, and so on. Further, the business logic classifications 246 may include steps for emergency response to an incident involving the product, steps for returning the product to a vendor, steps for packaging (or repackaging) of the product, steps for labeling of the product or packaging, other tasks, or any combination thereof.

The output data 206 may also include data related to one or more client tasks 250. For example, the business logic classifications 248 may specify that the product may be donated to a charity for reuse. The one or more client tasks 250 may indicate one or more procedures to donate the product, including internal company reporting and communication procedures.

The classification system 202 may be configured to communicate with one or more external transportation regulation data sources 208. The one or more transportation regulations data sources 208 may include department of transportation (DOT) data 210 (Federal, state, and so on), International Maritime Dangerous Goods (IMDG) data 212, International Air Transport Association (IATA) data 214, or any combination thereof

The classification system 202 may also be configured to communicate with one or more external waste handling regulation data sources 216. The waste handling regulations data sources 216 may include federal waste codes 218 (such as Resource Conservation and Recovery Act rules and regulations promulgated and enforced by the EPA), state waste codes 220 (such as state laws and regulations promulgated by state legislatures and environmental agencies), local waste codes 222 (such as county and municipal waste rules and regulations), or any combination thereof.

In some implementations, changes in regulatory data stored by the one or more transportation regulation data sources 208 or the waste handling regulation data sources 216 may trigger updates to the classification system 202. In an example, such changes may trigger the classification system 202 to generate an alert to an operator to review the changes.

The classification system 202 may include processing logic 224 to receive the product information 204. The processing logic 224 may include a data parser module 226 configured to extract data from the product information 204 and to load the extracted data into a temporary table or database, such as parsed data 228.

The processing logic 224 may further include a first principles module 230, which may access the parsed data 228 and reference data 232 and which may retrieve additional product data from one or more data sources based on the parsed data 228 related to the product information 204. The first principles module 230 may determine fundamental attributes of the product based on the product information and the retrieved additional product data. The first principles module 230 may use the one or more fundamental attributes to evaluate a plurality of logic expressions 234 to determine multiple deterministic classifications. For example, the logic expressions 234 may include Boolean logic expressions that may be used to determine the regulatory classifications deterministically. In an example, a Department of Transportation class 3 regulatory classification may be determined according to the following if-then statement:

IF (form=liquid) AND IF (Flashpoint<141° Fahrenheit (60.6° Celsius), then DOT Hazard Classification=3 (Equation 1)

In another example, an environmental regulatory classification may be determined according to the following Boolean expression:

If [(form=liquid) AND (Flashpoint<140° F.)] OR (Hazard class=2.1) OR (Hazard class=4.1, 4.2, or 4.3) OR (Hazard class=5.1 or 5.2) then EPA classification=RCRA D001 WASTE (Equation 2)

In still another example, an environmental regulatory classification may be determined according to the following expression:

If (Is aqueous) AND (form=liquid) AND (Concentration of H20>=50%) AND (pH<=2 OR pH>=12,5), then EPA Classification=RCRA D002 WASTE (Equation 3)

Equations 1-3 above depict logic expressions for determining a regulatory classification 246. Similar expressions may be used to evaluate options for handling of the product, such as donation, reuse, and so on. In an example, a product may be reused at the retail location provided that the regulatory classifications do not include a particular waste classification or a particular hazard classification, and so on.

The logic expressions 234 may take various forms, including Boolean expressions, if-then statements, other types of conditional statements, and so on. The logic expressions 234 may be established from regulatory guidelines and may be formed to provide a deterministic classification based on the fundamental attributes of the product. The information used to evaluate the logic expressions 234 may be determined from a safety data sheet (SDS) for the product, from information provided by a manufacturer or supplier, from third-party data sources, or any combination thereof.

In some instances, the first principles module 230 may perform one or more calculations 236 to determine additional information. The first principles module 230 may perform one or more lookups to the reference data 232, the parsed data, to other data sources, such as the transportation regulations data sources 208 or the waste handling regulation data sources 216.

The first principles module 230 may also include synthetic intelligence, such as a machine learning (ML) module 238. The machine learning module 238 may be configured to resolve ambiguities in lookup data, in various calculations, and so on. In one possible example, the machine learning module 238 may assign reliability values to one or more of the regulatory and business logic classifications. The machine learning module 238 may train using labeled data, training sets, other data, or any combination thereof In some implementations, after the machine learning module 238 is trained, the machine learning module 238 may be able to resolve ambiguities and data discrepancies without involving a human actor. Other implementations are also possible.

In some implementations, the plurality of logic expressions 234 of the first principles module 230 may include Boolean logic expressions, which may provide deterministic expressions for determining certain regulatory classifications 246 based on the fundamental attributes. The Boolean logic expressions may include one or more logic operators, such as AND, OR, NOR, ANDNOT, and the like. In some implementations, the first principles module 230 may use computational algorithms based on fundamental chemical structure theory to estimate a wide variety of reactivity parameters based on the composition data, the fundamental attributes, and the molecular structure of the various components. The first principles module 230 provides chemical modeling of the composition and reactions of the components of the composition with water, air, and other components used to determine the reactivity. In an example, the reference data 232 may include a sequence of chemical reactions and formulas, which may be applied to the parsed data to determine reactivity data. Further, the reference data 232 may include reactivity determination data, toxicity determination data, corrosivity determination data, and flammability determination data, which may be used in conjunction with the parsed data 228 to determine toxicity values, corrosivity values, flammability values, and reactivity values. These values may be part of the regulatory classifications 246. The regulatory classifications 246 may include a collection of classifications for the product that are generated based on the product information 204 per the rules of governmental, environmental, and transportation regulatory agencies. Examples of such classifications may include federal waste codes, state waste codes, United Nations (UN) numbers, hazard classes, packaging groups, proper shipping names, limited quantity exceptions, other information, or any combination thereof. In an example, the regulatory classifications 246 may be based, in part, on chemical composition data, and the first principles module 230 may use such data to determine chemical reactivity data, chemical corrosivity data, chemical toxicity data, flammability data, hazard data, transportation data, other data, or any combination thereof. In some implementations, the product information may also include a barcode, a universal product code (UPC), hazard class data, packing group data, United Nations (UN) numbers, proper shipping names (PSNs), other data, or any combination thereof.

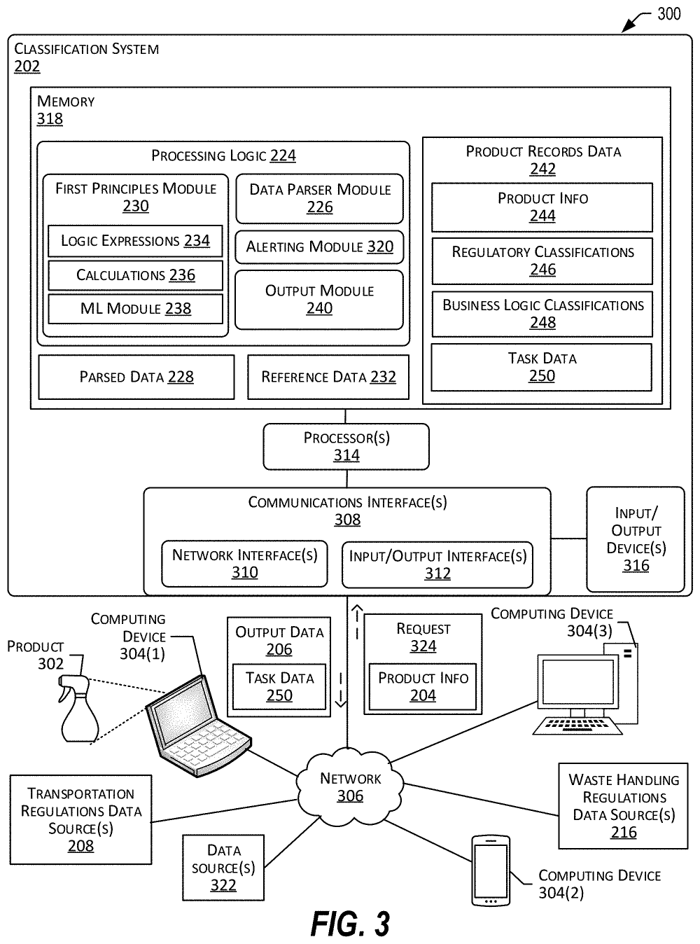

In the illustrated example, product information 204 related to a product (such as product 302 in FIG. 3) may be received. For example, a user may access a computing device to enter or provide product information 204 about the product 302 using a bar code reader, a camera, a keyboard, other data input devices, or any combination thereof. In one possible example, the user may utilize a computing device to scan the barcodes of the product 302, enter product information 204 related to the product using a keyboard or other input device, capture image data of packaging of the product 302 using a camera of the device, or otherwise provide product related information. In one possible example, an employee of a supplier or transporter of the product 302 may provide the product information 204.

Once the product information 244, the regulatory classifications 246, and the business logic classifications 248 for the product have been determined and stored in the product records database 242, the data from the products records database 242 may be used to produce the output data 206 in response to receiving the product information 204 for the same product. The processing logic 224 may identify a match in the product records database 242, retrieve the information, and provide the output data 206 to a computing device. Other implementations are also possible.

FIG. 3 depicts a block diagram of a system 300 including the classification system 202 to automatically determine regulatory and business logic data, in accordance with certain embodiments of the present disclosure. The classification system 202 may communicate with one or more computing devices 304 through a network 306, such as the Internet, to receive product information 204 related to a product 302. The computing devices 304 may include laptop computing devices 304(1), smartphones 304(2), desktop computing devices 304(3), other computing devices, or any combination thereof. One of the computing devices 304 may submit product information 204 to the classification system 202 and, in response, may receive output data 206 from the classification system 202.

In some implementations, the classification system 202 may communicate with one or more transportation data sources 208 through the network 306. The transportation data sources 208 may be maintained by one or more governmental agencies, such as the United States Department of Transportation (USDOT), a state transportation agency, or another agency or organization. Further, the classification system 202 may communicate with one or more waste handling regulations data sources 216. The waste handling regulations data sources 216 may be maintained by one or more governmental agencies, such as the United States Environmental Protection Agency (US EPA), by state environmental agencies, by municipalities, or any combination thereof

The classification system 202 may include one or more communications interfaces 308 including one or more network interfaces 310 and one or more input/output (I/O) interfaces 312. The one or more network interfaces 310 may communicatively couple the classification system 202 to the network 306. The one or more input/output interfaces 312 may be coupled to one or more input/output (I/O) devices 316. The I/O devices 316 may include input devices, such as keyboards, microphones, scanners, barcode readers, other input devices, or any combination thereof. The I/O devices 316 may also include output devices, such as displays, printers, speakers, other output devices, or any combination thereof.

The classification system 202 may include one or more processors 314 coupled to the communications interfaces 308. The classification system 202 may further include one or more memories 318 coupled to the one or more processors 314. The memory 318 may store data and processor-readable instructions that may be executed by the processor 314.

The memory 318 may include the processing logic 224 including the data parser module 226, the first principles module 230, the output module 240. In response to receiving the product information 204 from one of the computing devices 304, such as the computing device 304(1), the data parser module 226 may cause the processor 314 to extract data from the product information 204 and normalize the extracted data. The processing logic 224 may retrieve additional information from one or more data sources, such as the product records data 242, one or more data sources 322 accessible through the network 306, another data source, or any combination thereof. The data parser module 226 may extract data from the various sources and populate one or more tables with the data, which tables may be stored as parsed data 228.

The first principles module 230 may cause the processor 314 to determine fundamental attributes from the data extracted using the parsed data 228, reference data 232, logic expressions 234, calculations 236, or any combination thereof. The first principles module 230 may apply the logic expressions 234 to the fundamental attributes to determine regulatory and business logic classifications based on the product information, the retrieved data, and the fundamental attributes. In some instances, the first principles module 230 may perform one or more calculations 236 on portions of the data. Further, a machine learning module 238 may be configured to automatically determine portions of the regulatory and business logic classifications and, in some instances, to automatically resolve ambiguities or discrepancies. In one example, the machine learning module 238 may be used to resolve a discrepancy between a regulatory classification indicated on an SDS for the product 302 and the regulatory classification determined by the classification system 202.

The memory 318 may include an alerting module 320 that, when executed, may cause the processor 314 to send a message to a computing device 304 associated with an expert or administrator. The message may include a text message, an email, a web portal interface, a phone call, another type of alert, or any combination thereof. For example, in response to the machine learning module 238 resolving a discrepancy, the alerting module 320 may send an alert to the computing device 304 associated with the expert so that the expert may review and verify or review and reject the automated determination.

The memory 318 may further include product records data 242 including a plurality of product records. The product records data 242 may include product information 244, regulatory classifications 246, business logic classifications 248, and task data 250. The task data 250 may reflect one or more actions to be taken by a user based on the regulatory classifications 246 and the business logic classifications 248. One or more of the product records 242 may include additional information, such as feedback data or other data. Other implementations are also possible.

In some examples, the classification system 202 may be configured to receive product data 204 from one or more computing devices 304 as part of a request. The request may include information related to a business task, such a donation task, a return task, and so on. In one example, the computing device 304(1) may provide product information 204(1) that is related to a product 302. The product 302 may be an unsaleable product. The product 302 may be unsaleable because of damaged packaging, because it was returned to the retailer, or for various other reasons. In response to receiving the product information 204, the classification system 202 may search the product records data 242 to determine the product information 244, the regulatory classifications 246, the business logic classifications 248, and the task data 250 based on the request including the product information 204. The classification system 202 may provide the output data 206 including the task data 250 to the computing device 304(1).

The classification system 202 may receive multiple submissions of product information 204 from different computing devices 304 and may determine the product records data 242 for each request 324 and send output data 206 including information related to the request 324. If the request 324 requests information about donating the product 302, the task data 250 may include information to guide the user through a process of donating the product 302 (if the product 302 may be donated). If the guidelines indicate that donation is not possible or not recommended, the task data 250 may include information indicating one or more actions to be taken by the user to perform an alternative task or providing an alternative recommendation.

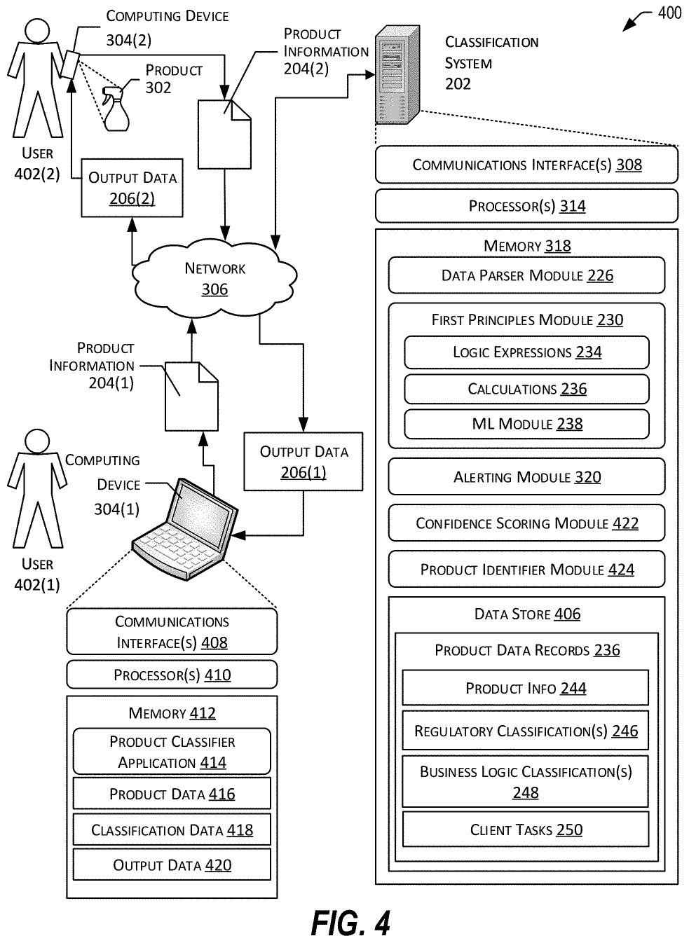

FIG. 4 depicts a block diagram of a system 400 including the classification system 202 of FIGS. 1-3, in accordance with certain embodiments of the present disclosure. The classification system 202 may communicate with one or more computing devices 304(1) and 304(2) through a communications network 306, such as the Internet.

A user 402(2) may interact with a computing device 304(2) to capture information about a product 302. In some implementations, the computing device 304 may be a portable computing device, such as a smartphone, a tablet computer, a laptop computer, or another computing device. In other implementations, the computing device 304 may be a desktop computer or another computing device that may be used by the user 402 to enter data associated with a product 302.

The computing device 304 may include a communications interface 408, which may include input/output interfaces that may couple to input/output devices, such as keyboards, displays, touchscreens, pointer devices, printers, barcode readers, cameras, other devices, or any combination thereof. The communications interface 408 may also include network interfaces, which may be configured to communicate with one or more networks, such as the network 306. The network 306 may include one or more networks, including local area networks, wide area networks, communications networks, the Internet, or any combination thereof. Other interfaces are also possible.

The computing device 304 may also include one or more processors 410 configured to execute processor-readable instructions and to access data stored in a memory 412. The memory 412 may include a product classifier application 414 that be accessed by the user 402 via one of the communications interfaces 408 to enter product information 204 about a product 302. In some implementations, the memory 412 may store product data 416 including image data, data entered by a user, composition data, and other data. The memory 412 may also store classification data 418 received from the classification system 202, other output data 420 received from the classification system 202, other data, or any combination thereof. In some implementations, a user 402 may utilize the product classifier application 414 of the computing device 304 to capture information about an unsaleable product 302. The product classifier application 414 may search the memory 412 to determine classification data 420 for the unsaleable product 302. If classification data 420 is found that is related to the unsaleable product 302, the product classifier application 414 may present transportation information, hazard information, waste handling guidelines, and other data associated with the unsaleable product 302 to an input/output device, such as a display of the computing device 304. Alternatively, if the classification data 420 is not found, the computing device 304 may send the product information 204 to the classification system 202.

In response to sending the product information 204, the computing device 304 may receive output data 206 from the classification system 202. The output data 206 may include product information 244, regulatory classifications 246, business logic classifications 248, and task data 250. In some implementations, the regulatory classifications 246 may include both transportation and hazard codes corresponding to the product. The business logic classifications 248 may include data determined from company information as applied to the product information. The task data 250 may include one or more workflows or tasks to be performed by the user 402.

The classification system 202 may include one or more communications interfaces 308. The communications interfaces 308 may include input/output interfaces that may communicate with one or more input/output devices. The output devices may include display devices, printers, speakers, and so on. The input devices may include a scanner, a camera, a keyboard, a pointer, a microphone, and so on. The communications interfaces 308 may further include one or more network interfaces that may be configured to communicate with a network 306.

The classification system 202 may include one or more processors 314, which may be coupled to the communications interfaces 308 and to one or more memories 318, which may store data and processor-readable instructions. The processors 314 may be configured to execute processor-readable instructions.

The memory 318 may include a data parser module 226 configured to receive the product information 204, to extract data from the product information 204, and to store the extracted data into one or more temporary tables or database records. For example, the data parser module 226 may extract chemical composition data from the product information 204 and may put the extracted data into a data table for further processing. In some implementations, the data parser module 226 may retrieve additional data from one or more data sources and may add the additional data to the data table.

The memory 318 may also include a first principles module 230, which may receive extracted data from the data parser module 226 and which may process the extracted data using a plurality of logic expressions 234, one or more calculations 236, and a machine learning module 238 to determine regulatory classifications 246 and business logic classifications 248 based on the product information. The machine learning module 238 may be trained to identify information that is important with respect to one or more of the regulatory classifications 246 or the business logic classifications 248. For example, the machine learning module 238 may resolve discrepancies between SDS data associated with the product and the determined regulatory classifications 246 and the business logic classifications 248. The machine learning module 238 may also determine features of the composition, predict answers, perform logical regression analysis, and so on. The machine learning module 238 may be implemented as an artificial intelligence engine, a neural network, one or more decision trees, another machine learning system, or any combination thereof. Other implementations are also possible.

The memory 318 may include an alerting module 320 that may generate an interface, an email, a text message, a phone call, or another electronic message. For example, in response to determining a discrepancy between an SDS document for a product 302 and one or more of the regulatory classifications 246 or the business logic classifications 248, the alerting module 320 may generate an email or other alert to an expert to review the data and resolve the discrepancy.

The memory 318 may further include a confidence scoring module 422. The confidence scoring module 422 may determine reliability values for each data item of the regulatory classifications 246, the business logic classifications 248, and the product information 244. The confidence scoring module 422 may evaluate bases for uncertainty in each calculation and may assign confidence scores or reliability values reflecting a degree of certainty with respect to each calculation or with respect to each logical expression. In an example, the confidence scoring module 422 may assign a probability or reliability based on historical data, statistical calculations, other data, or any combination thereof.

In one example, the data parser module 226 may extract the data from the product information 204 and from other data sources, and the confidence scoring module 422 may determine a confidence score for each data item from the data parser module 226. In one example, the confidence scoring module 422 may assign a parser confidence score of 0.9 (on a scale of zero to one). The first principles module 230 may calculate the various data values, and the confidence scoring module 422 may determine a confidence score for each data item from the first principles module 230. In an example, the confidence scoring module 422 may assign a first principles confidence score of 0.9 to a first regulatory classification and to a first business logic classification. The machine learning module 238 may determine one or more attributes of the product 302 based on the product information 204, and the confidence scoring module 422 may determine a confidence score for each data item from the machine learning module 238. For example, the confidence scoring module 422 may assign a confidence value of 0.9. The confidence scoring module 422 may determine an overall confidence or reliability score as follows:

1−(1−0.9)³=99.9% reliability (Equation 1)

If one or more of the confidence scores or reliability values are below a threshold level, the alerting module 320 of the classification system 202 may send an alert to a computing device 304 associated with a user 402 to request clarification or may forward the product information 244, the regulatory classifications 246, the business logic classifications 248, and the client tasks 250 together with the confidence scores or reliability values to an operator or expert for review. In one possible example, the threshold reliability may be 99%. In another possible example, the threshold reliability may be 90%. Other thresholds are also possible. Otherwise, if the confidence scores are above a threshold level, the confidence scoring module 422 may provide the output 206 including the product information 244, the regulatory classifications 246, the business logic classifications, and the client tasks 250.

The memory 318 may include a product identifier module 424. In some implementations, the product identifier module 424 may identify the product 302 based on the product information 204. For example, the product identifier module 424 may determine the product name and may retrieve safety data sheet (SDS) data and other data associated with the product 302 from memory 318, from a database, or from another trusted data source. In some implementations, the product identifier module 424 may definitively identify the product 302 based on product data records 236 in the data store 406. The data store 406 may store product data records 236 as well as other data.

In operation, the classification system 202 may be configured to capture product information 204 associated with a product 302. The product information 204 may include regular expressions, natural language, images, and so on in a semi-structured format, such as input from a web-based form. In some instances, the product information 204 may include the SDS for the product 302. The SDS may include a listing of all active ingredients in the product 302 that have a concentration greater than a threshold concentration. In an example, the threshold concentration may be one percent. The SDS may include carcinogen data, reproductive toxin data, and other data with respect to composition elements in concentrations greater than 0.1 percent. Further, the SDS may include DOT, IMDG, and IATA data, but may not include packaging information. Further, the SDS may include transportation data that does not include packaging. Because the SDS does not include the packaging data and because the SDS may include errors, further processing may be desirable to confirm transportation and handling rules.

In an example, an aerosol may be flammable. However, for DOT regulation purposes, an aerosol may with a volume of less than six ounces may be deemed non-flammable for transportation purposes. Thus, the packaging may impact the transportation classification. If the same aerosol were bundled into a two-pack, the DOT regulations may specify the twelve-ounce packaging as flammable, which may be more expensive and have more extensive handling rules than the single-item packaging.

In one example, a company may utilize the classification system 202 to evaluate marketing offers to avoid unintentionally increasing shipping costs by combining products into multipack units that might increase the cost of shipping. In another example, the classification system 202 may be used to evaluate a product for donation purposes to determine whether the product may be reused. Other implementations are also possible.

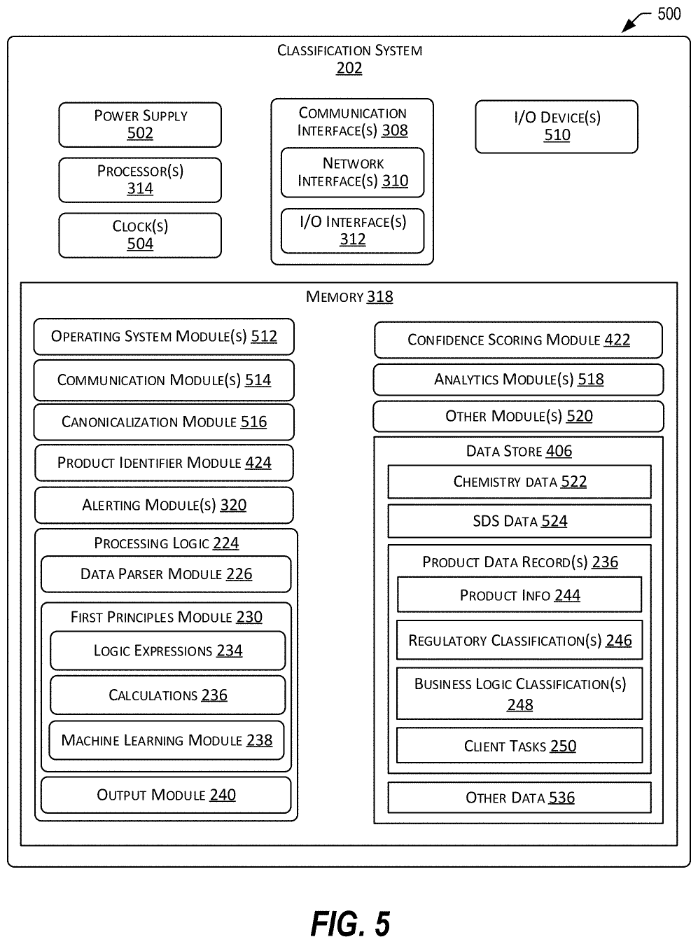

FIG. 5 depicts a diagram 500 of the classification system 202 of FIGS. 1-4, in accordance with certain embodiments of the present disclosure. The classification system 202 may include a power supply 502 to supply power to the various components of the classification system. Further, the classification system 202 may include one or more processors 314, which may be configured to execute processor-executable instructions stored in the memory 318. The classification system 202 may further include one or more clocks 504 configured to provide ticks or timing signals, which may be used to timestamp data and optionally to drive operation of various components.

The classification system 202 may further include one or more communications interfaces 308. The one or more communications interfaces 308 may include one or more input/output (I/O) interfaces 312, which may communicate with I/O devices 510. The I/O devices 510 may include input devices, such as keyboards, touchscreens, microphones, scanners, pointer devices, cameras, removable storage devices (such as solid-state drives, thumb drives, and the like), barcode readers, other input devices, or any combination thereof. The I/O devices 510 may also include output devices, such as printers, displays, speakers, other devices, or any combination thereof. The I/O interfaces 312 may include a universal serial bus (USB) port, a high-definition multimedia interface (HDMI), other ports, other interfaces, or any combination thereof

The one or more communications interfaces 308 may also include one or more network interfaces 310. The one or more network interfaces 310 may include wired interfaces, such as an RJ-45 Ethernet port, or wireless interfaces, such as a Bluetooth transceiver, an IEEE 802.11x interface, other short-range wireless interfaces, long-range wireless interfaces (e.g., Wi-Fi, cellular network interfaces, and so on), other interfaces, or any combination thereof.

The classification system 202 may further include one or more memories 318. The one or more memories 318 may include non-volatile memory devices, such as solid-state hard drives, hard disc drives, hybrid data storage devices, or any combination thereof. The one or more memories 318 may store processor-executable instructions and may store data.

The memory 318 may include one or more operating system modules 512 that may control operation of the classification system 202. The memory 318 may further include one or more communication modules 514 that may control operation of the communication interfaces 308. The memory 318 may include a canonicalization module 516 to normalize received data. The memory 318 may also include a product identifier module 424, an alerting module 320, and processing logic 224. The product identifier module 424 may be configured to determine information about the product based on the product information 204. In some implementations, the product identifier module 424 may determine a barcode, a universal product code (UPC), or other identifier information from the product information, and may use the identifier to retrieve data about the product. Other implementations are also possible.

The data parser module 226 may extract data from the product information received from the user device, from the information retrieved from one or more data sources, and so on. The data parser module 226 may provide the extracted data to the canonicalization module 516 to normalize the data, and may then organize the extracted data into one or more categories of information, a temporary table, or another data structure.

The memory 318 may also include a confidence scoring module 422. The confidence scoring module 422 may determine reliability values for each calculated value, for each regulatory classification 246, and for each business logic classification 248. In some implementations, the confidence scoring module 422 may provide a confidence value or reliability value for each data item.

The memory 318 may also include processing logic 224, which may be implemented in software. In an alternative implementation, the processing logic 224 may be implemented in circuitry. In this implementation, the processing logic 224 may include a first principles classification module 230, which apply a plurality of logic expressions 234 and one or more calculations 236 to determine regulatory classifications 246 and business logic classifications 248.

The processing logic 224 may further include a machine learning module 238 that may cause the processor 314 to evaluate the regulatory classifications 246 and the business logic classifications 248. In some implementations, the machine learning classification module 238 may be configured to automatically evaluate various classifications. Over time, the machine learning classification module 238 may be trained to resolve discrepancies in the data and to determine various aspects that may be more important than other aspects. Other implementations are also possible.

The processing logic 224 may also include an output module 240 to provide output data 206 to a computing device 304. The processing logic 224 may include the alerting module 320, which may generate one or more messages, or which may provide interfaces to a computing device 304 through a network 306. In one possible example, the alerting module 320 may provide an interface through which an operator (such as a hazard classification expert or other user) may review the product information 244, the regulatory classifications 246, the business logic classifications 248, other data, or any combination thereof. In some implementations, the alerting module 320 may send information related to the handling and disposal of the product 302 to a computing device 304 associated with a user 402 in response to receiving the product data 204 from the computing device 304. Further, the alerting module 320 may notify a supplier in response to the analytics module 518 detecting a discrepancy between the determined regulatory classifications 246 for the product and the SDS data 524 for the product.

The classification system 202 may include an analytics module 518, which may be configured to process the determined classification data for a product 302 relative to an existing safety data sheet (SDS) for the product from SDS data 534. For example, the analytics module 518 may compare the determined regulatory classifications 246 and the business logic classifications 248 to the classifications in the SDS. The analytics module 518 may also determine that the product information 204 is insufficient to determine fundamental attributes of the product. The memory 316 may also include other modules 520.

The memory 318 may also include a data store 406 to store chemistry data 522, such chemical properties and reaction information. The data store 406 may also include SDS data 524. Other implementations are also possible.

The data store 406 may also store product data records 236. The data store 406 may include product information 244, regulatory classifications 246, business logic classifications 248, and client tasks 250. The data store 406 may also store other data 526.

In some implementations, the classification system 202 may be configured to receive product information 244 associated with a product 302. The classification system 202 may automatically process the product information 204, may retrieve additional product data, and may use the first principles module 230 to automatically determine regulatory classifications 246 and business logic classifications 248 associated with the product 302. Other implementations are also possible.

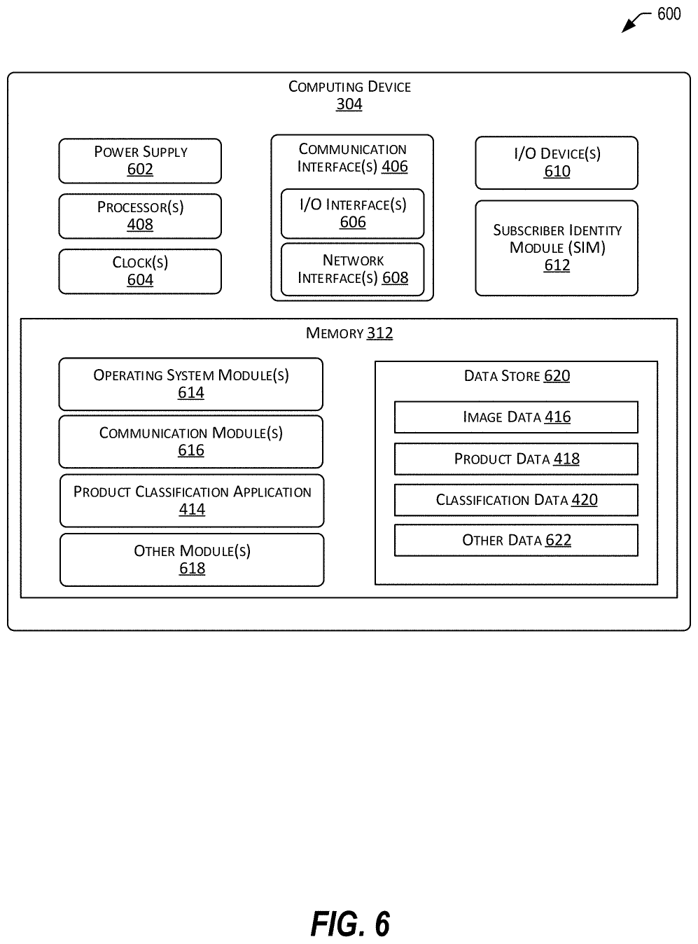

FIG. 6 depicts a diagram 600 of a computing device 304 that may be used in conjunction with the systems of FIGS. 1-5, in accordance with certain embodiments of the present disclosure. The computing device 304 may include a power supply 602 to supply power to one or more components of the computing device 304. The computing device 304 may further include one or more processors 408 to execute processor-readable instructions. The computing device 304 may also include one or more clocks 604, which may provide ticks or timing signals that may be used by one or more of the components.

The computing device 304 may include communication interfaces 406 such as those discussed above with respect to the classification system 202. The communication interfaces 406 may include I/O interfaces 606 with may communicate with one or more I/O devices 610. The I/O devices 610 may include keyboards, pointers, scanners, cameras, barcode readers, microphones, other input devices, or any combination thereof. The I/O devices 610 may further include display devices, touchscreens, printers, speakers, other output devices, or any combination thereof.

The communication interfaces 406 may further include one or more network interfaces 608, which may be configured to communicatively couple the computing device 304 to a network, such as the network 306 in FIG. 3. The network interfaces 608 may include interfaces to communicatively couple the computing device 304 to a communications network, such as a cellular, digital, or satellite communications network, or to short-range communication networks, such as a Bluetooth® communication link or another communications network.

The computing device 304 may include a subscriber identity module (SIM) 612. The subscriber identity module 612 (or subscriber identification module (SIM), which is sometimes called a “SIM card”) may include an integrated circuit that is intended to securely store the international mobile subscriber identity (IMSI) number and its related key, which may be used to identify and authenticate subscribers on mobile telephony devices (such as mobile phones and computers).

The computing device 304 may also include a memory 312, which may include one or more memory devices, such as non-volatile memory devices (such as solid-state drives, hard disc drives, optical drives, other storage devices, or any combination thereof). The memory 312 may also include cache memory devices, flash memory devices, other memory devices, or any combination thereof.

The memory 312 may store processor-readable instructions and may store data. The memory 312 may include one or more operating system modules 614, which may control operation of one or more components of the computing device 304. The memory 312 may also include one or more communication modules 616, which may control operation of the communication interfaces 308.

The memory 312 may include a product classification application 414 that, when executed, may cause the processor 408 to provide a graphical interface to a display. The graphical interface may guide the user 402 to enter data corresponding to an unsaleable product 302. In some implementations, the product classification application 414 may cause the processor 408 to prompt the user 402 to capture data related to the related to the unsaleable product 302. The captured data may include weight data, image data, composition data, other data, or any combination thereof. The product classification application 414 may search a data store 620 determine if classification data 420 includes the regulatory classifications 426, the business logic classifications 428, other product information, or any combination thereof If the data store 620 includes such information, the product classification application 414 may determine the regulatory classifications 426, business logic classifications 428, task data 430, or any combination thereof, locally, without having to send a request to the classification system 202. Otherwise, the product classification application 414 may send a request including product information to the classification system 202 and, in response to sending the request, may receive output data 206 from the classification system 202.

The memory 312 may also include other modules 618, such as printer control modules, alerting modules, and so on. The memory 312 may further include a data store 620, which may store image data 416, product data 418, classification data 420, and other data 622.

In some implementations, the computing device 304 may be portable, such as smartphone, tablet computer, laptop computer, and the like. A user 402 may interact with the computing device 304 to capture data associated with the unsaleable product 302. The captured data may include images, product information, chemical composition data, other data, or any combination thereof. The user may access a product classification application 414 to determine regulatory classifications 426 and business logic classifications 428 for the product 302. Other implementations are also possible.

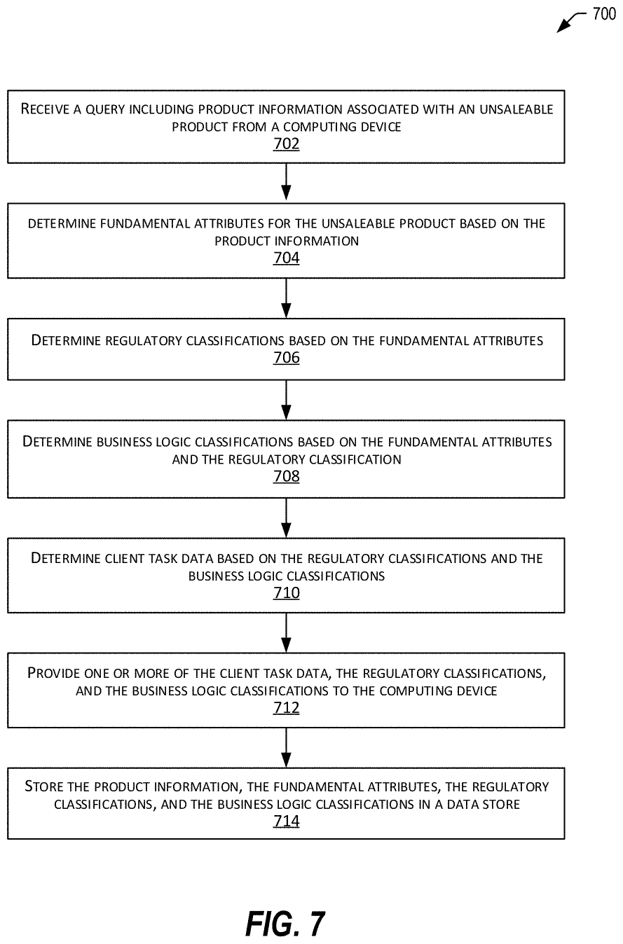

FIG. 7 depicts a diagram 700 of a method of automatically determining regulatory classifications and business logic classifications of an unsaleable product, in accordance with certain embodiments of the present disclosure. At 702, product information associated with an unsaleable product may be received. The product may be unsaleable because the product packaging is damaged, the product is discarded as waste, and so on.

At 704, product data is determined for the unsaleable product based on the product information. The product data may be retrieved from one or more data sources. For example, the classification system 202 may retrieve SDS documents and other data based on the product information and may extract the product data from the retrieved information. In some examples, the product data may include fundamental attributes of the product, such as chemical properties, intended use, packaging type and dimensions, physical properties, and so on.

At 706, regulatory classifications may be determined for the unsaleable product based on the product data. The regulatory classifications 246 may be determined based on logical expressions 234, one or more calculations 236, and decisions by the machine learning module 238. For example, the logical expressions 234 may include Boolean logic operators (e.g., AND, OR, and the like), mathematical operations, or any combination thereof.

At 708, business logic classifications may be determined for the unsaleable product based on the regulatory classifications 246 and the product data. The business logic classifications 248 may determine rules or guidelines for transportation of a product by land, air, or sea; disposal of a product; recycling of a product; donation of a product to a charity (i.e. reuse); emergency response to an incident involving a product; returning a product to vendor; packaging of a product; labeling of a product, or any combination thereof.

At 710, the classification system may determine client task data 250 based on the regulatory classifications 246 and the business logic classifications 248. For example, the classification system 202 may determine the regulatory classifications 246 and the business logic classifications 248 based on fundamental attributes, which may include the chemical composition, hazard data, transportation data, a packing group, a UN number, a proper shipping name, other information, or any combination thereof

At 712, one or more of the client task data, the regulatory classifications, and the business logic classifications are provided to the computing device. In some implementations, the classification system 202 may provide an interface via the network 306, where the interface may include one or more of client task data, the regulatory classifications, and the business logic classifications. Other implementations are also possible.

At 714, the product information, the fundamental attributes, the regulatory classifications 246, and the business logic classifications 248 are stored in a data store. The data store may be part of the classification system 202 or may be a data source accessible via a network 306. Other implementations are also possible.

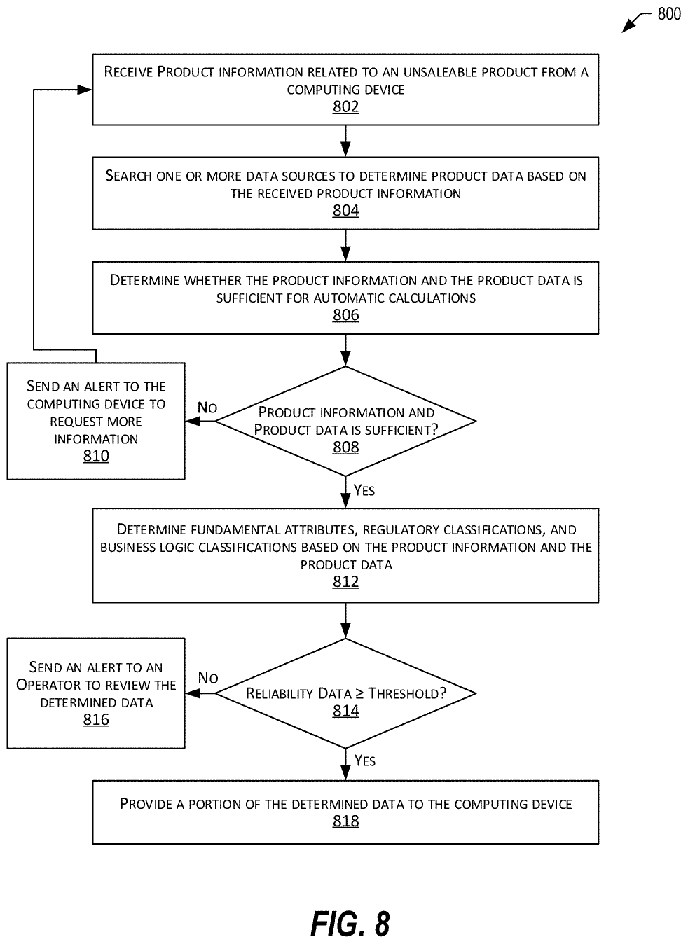

FIG. 8 depicts a diagram 800 of a method of providing regulatory and business logic classifications for a product based on associated reliability data, in accordance with certain embodiments of the present disclosure. At 802, information related to an unsaleable product may be received from a computing device. The information may include images, text, SDS data, other data, or any combination thereof. The information may be received from a computing device associated with a user or from another computing device.

At 804, product information is determined by searching one or more data sources based on the received information. The one or more data sources may include databases, websites, other data sources, or any combination thereof.

At 806, the system may determine whether the product information includes sufficient information for automatic calculations. For example, certain information may be needed in order to complete the logic expressions 234 and the calculations 236 with reliability. If such information is not included in the product information and cannot be readily retrieved based on the product information, the classification system 202 send an alert. At 808, if the product information is insufficient, an alert may be sent to the computing device to request for more information, at 810. The method may then return to 802 to receive information related to the unsaleable product from the computing device.

Returning to 808, if the product information includes sufficient information, the system may determine fundamental attributes, regulatory classifications, and business logic classifications based on the product information and the product data, at 812. In some implementations, the determination may include brute force calculations of chemical reactions as well as data retrieval from one or more data sources or tables. In other implementations, the classification system 202 may apply deterministic logic expressions to the product data to determine the regulatory and business logic classifications. Other implementations are also possible.

At 814, if the reliability data is less than a threshold, an alert may be sent to an operator to review the determined data, at 816. In some implementations, the alert may include an email, a text, a call, or another indicator, which may direct the user to visit a web portal or to access an application interface to review, edit, and optionally authenticate the determined data. In other implementations, the alert may include an interface including one or more user-selectable options accessible by a user to review, edit, and optionally authenticate the determined data. Other implementations are also possible.

At 814, if the reliability is greater than or equal to a threshold, a portion of the determined data may be provided to the computing device, at 818. The portion may include at least some of the determined data. In some implementations, the system may provide an interface including the output data 206 to the computing device. The requested data may include a client task, such as , or any combination thereof

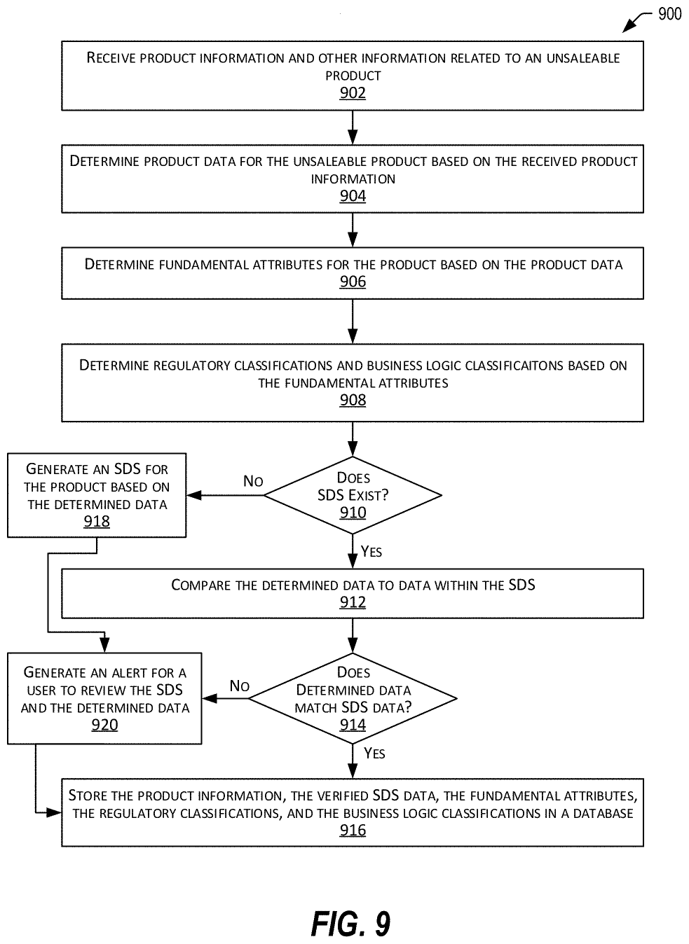

FIG. 9 depicts a diagram 900 of a method of automatically producing a safety data sheet for a product, in accordance with certain embodiments of the present disclosure.

In some instances, SDS information may be incorrect, and the system may identify errors in the SDS information. In other instances, the system may determine that an SDS for the product does not yet exist, and the system may automatically generate the SDS based on one or more of the product information, the fundamental attributes, the regulatory classifications, and business logic classifications. Other implementations are also possible.

At 902, product information and other information for an unsaleable product may be received. The product information and other information may be received from inputs from a user device, retrieved from one or more data sources, or any combination thereof.

At 904, product data for the unsaleable product may be determined based on the received product information. The product data may include SDS documentation, chemical composition data, UPC data, other data, or any combination thereof. In some implementations, the classification system 202 may determine the product data by searching one or more data sources.

At 906, fundamental attributes are determined based on the product data. In some implementations, the product data may be used to look up product information and chemical composition data from one or more data sources.

At 908, regulatory classifications and business logic classifications may be determined based on the fundamental attributes. The fundamental attributes may include chemical properties, intended use, packaging type and dimensions, physical properties, and so on. The classification system 202 may apply a plurality of logic expressions 234 to determine a collection of regulatory classifications 246 and business logic classifications 248 for a product that are generated per the rules of governmental, environmental, and transportation regulatory agencies. Examples of such classifications may include federal waste codes, state waste codes, United Nations (UN) numbers, hazard classes, packaging groups, proper shipping names, limited quantity exceptions, other information, or any combination thereof. In some implementations, the product data may also include a barcode, a universal product code (UPC), hazard class data, packing group data, United Nations (UN) numbers, proper shipping names (PSNs), other data, or any combination thereof.

At 910, it may be determined whether an SDS already exists for the product. If the SDS exists, the determine data may be compared to the data within the SDS, at 912. In an example, the system may extract the data from the SDS to populate one or more fields and may compare the determined data to the SDS data.

At 914, if the determined data matches the SDS data, the product information, the verified SDS data, the fundamental attributes, the regulatory classifications, and the business logic classifications may be stored in a database, at 916. The database may be stored in a memory of the classification system or may be an external database. Other implementations are also possible.

Returning to 910, if the SDS does not exist, an SDS may be generated for the product based on the determined data, at 918. The system may generate an SDS form for the product by populating fields of an SDS template with data from the regulatory classifications 246, the business logic classifications 248, the product information 244, or any combination thereof to produce the SDS for the product. Other implementations are also possible.

At 920, an alert may be generated for a user to review the SDS and the determined data. The alert may include an email, a text, a call, or other electronic message to provide information to the user, and optionally to direct the user to visit a web portal to review the SDS and the determined data. In one possible example, the alert may include a graphical interface to present the SDS, product information, reliability data, other data, or any combination thereof. A user may interact with the graphical interface to review, edit, and optionally validate the generated SDS. Other implementations are also possible.

The product information 244, the verified SDS data, the regulatory classifications 246, and the business logic classifications 248 may be stored in the database, at 916. In some implementations, data related to the product information 244, the verified SDS data, the regulatory classifications 246, and the business logic classifications 248, or any combination thereof may be provided to a computing device. Other implementations are also possible.

Returning to 914, if the determined data does not match the SDS data, an alert may be generated for the user to review the SDS and the determined data, at 920. In some implementations, the alert may specify one or more data items within the SDS that are not a match to the calculated data, together with the calculations, so that the user may determine which is correct. The user may then update the SDS with the correct information or may validate the existing information. Other implementations are also possible.

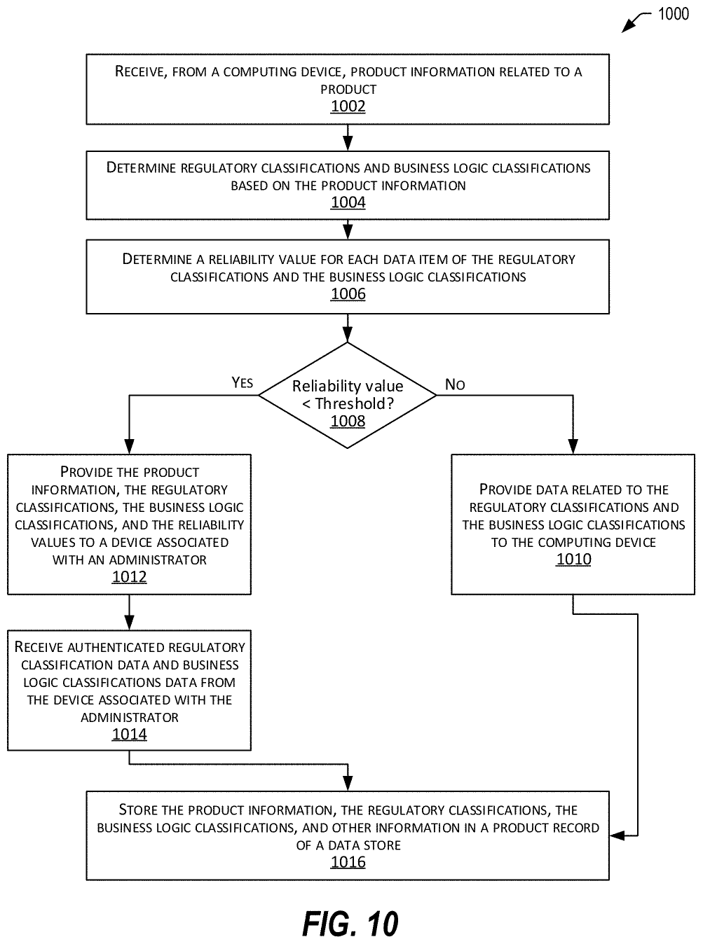

FIG. 10 depicts a diagram 1000 of a method of providing regulatory and business classifications, in accordance with certain embodiments of the present disclosure. At 1002, product information related to a product may be received from a computing device. The product information may be related to an unsaleable product, such as a damaged product, a returned product, or a waste product. The product information may include pictures, text, data sheets, other information, or any combination thereof. The system may parse the product information into a plurality of pre-determined categories of information. The system may also retrieve further information based on the product information. In some implementations, the further information may be retrieved from one or more data sources, including websites, databases, users, other data sources, or any combination thereof. In one possible implementation, the further information may be retrieved from a product database. Other implementations are also possible.

At 1004, regulatory classifications and business logic classifications may be determined based on the product information. In some implementations, the system may determine chemical composition data associated with the product. Further, the system may use fundamental attributes, such as the chemical composition, to evaluate a plurality of logic expressions 234 to determine the regulatory classifications 246 and the business logic classifications 248.

At 1006, a reliability value may be determined for each data item. For example, each data item of the regulatory classifications 246 and the business logic classifications 248 may be determined. Inconsistencies in the input data may lower the reliability data. For example, if the calculated corrosivity data differs from the corrosivity value in the SDS, the reliability value associated with the corrosivity data may be lower than if the values matched. Further, in some implementations, certain combinations of chemicals may make it difficult to definitively determine the chemical properties of the product, and the resulting calculation may include a reliability value indicative of the uncertainty.

At 1008, if the reliability value greater than or equal to a threshold, data related to the regulatory classifications and the business logic classifications may be provided to the computing device, at 1010.

At 1016, the product information, the regulatory classifications, the business logic classifications, and other information may be stored in a product record of a data store. The data store may be part of the classification system 202 or may be a separate database. Other implementations are also possible.

Returning to 1008, if the reliability value is less than the threshold, the product information, regulatory classifications 246, business logic classifications 248, and the reliability values may be provided to a device associated with an administrator, at 1012. In some implementations, the administrator may be an expert with respect to chemical reactions, hazard classification determinations, transportation classification determinations, other data, or any combination thereof.

At 1014, authenticated regulatory classification data and business logic classifications data may be received from the device associated with the administrator. In one possible example, the system may provide a graphical interface to the device associated with the administrator. The graphical interface may include the product information, other information, the calculated regulatory classification data 246, business classification data 248, and user-selectable options accessible by a user to edit and optionally validate one or more portions of the product data, the regulatory classifications, or the business logic classifications.

At 1016, the product information, regulatory classification data 246, business classification data 248, and other information may be stored in a product record of the data store. Other implementations are also possible.

In conjunction with the systems, methods, and devices described above with respect to FIGS. 1-10, a classification system 202 may utilize product information 204 to determine fundamental attributes associated with a product 302. The fundamental attributes may provide a chemical description of the product 302, including composition data, reactivity data, toxicity data, corrosivity data, flammability data, and other data. The classification system 202 may also determine regulatory classifications and business logic classifications for the product 302 based on the product information 244. The classification system 202 may provide an output 206 including at least a portion of the product information 244, the regulatory classification data 246, the business classification data 248, and the task data 250 to a computing device 304.

In some implementations, the classification system 202 may determine a reliability score that is below a threshold and may generate an alert to an operator to review the product information 244, the regulatory classification data 246, the business classification data 248, or any combination thereof. In some implementations, the alert may allow the user to review, edit, and optionally authenticate the data. Other implementations are also possible.

In some implementations, the classification system 202 may be configured to generate an SDS for a product based on the product information 244, the regulatory classifications 246, the business logic classifications 248, or any combination thereof. In some instances, the classification system 202 may determine the validity of the SDS data by comparing the SDS data to the product information 244, the regulatory classifications 246, the business logic classifications 248, or any combination thereof and determining discrepancies for review by an expert or for analysis by the machine learning module 238. Other implementations are also possible.

Although the present invention has been described with reference to preferred embodiments, workers skilled in the art will recognize that changes may be made in form and detail without departing from the scope of the invention.

What is claimed is:

1. A system comprising:
a communications interface;
a processor coupled to the communications interface; and
a memory to store data and to store processor-readable instructions to cause the processor to:
receive product information associated with a product;
determine product data for the product based on the product information, the product data including chemical composition data;
apply a plurality of logic expressions and calculations to the product data to determine regulatory classifications for the product and business logic classifications for the product; and
provide output data including data related to one or more of the product data, the regulatory classifications, and the business logic classifications.

2. The system of claim 1, wherein the processor-readable instructions cause the processor to:
receive a safety data sheet (SDS) associated with the product;
determine difference data between the SDS and one or more of the product data, the regulatory classifications, and the business logic classifications; and
provide an alert including the difference data to a computing device.

3. The system of claim 1, wherein the processor-readable instructions to cause the processor to:
automatically generate a safety data sheet (SDS) for the product based on one or more of the product data, the regulatory classifications, and the business logic classifications; and
provide an alert including the generated SDS to a computing device.

4. The system of claim 1, wherein the regulatory classifications comprise United States Department of Transportation codes and corresponding rules for transportation of the product on roads, on waterways, or through the air.

5. The system of claim 1, wherein the regulatory classifications comprise United States Environmental Protection Agency codes and corresponding rules for handling and disposal of the product.

6. The system of claim 1, wherein the business logic classification comprises one or more of:
guidelines for transportation of a product by land, air, or sea;
disposal of a product; recycling of a product;
donation of a product to a charity;
emergency response to an incident involving a product;
return of the product to a vendor;
packaging of a product; or
labeling of a product.

7. The system of claim 1, wherein the plurality of logic expressions include one or more of a lookup, a Boolean expression, and a multi-variable if-then statement.

8. The system of claim 1, wherein the processor-readable instructions cause the processor to:
determine a plurality of reliability values, each reliability value associated with a data item of one of the product data, the regulatory classifications, and the business logic classifications;
determine one of the plurality of reliability values is less than a threshold reliability; and
provide an alert indicative of the data item and a basis for the associated reliability value to a computing device.

9. A method comprising:
receiving, at a classification system, product information associated with a product;
determining chemical composition data for the product based on the product information;
applying a plurality of logic expressions to the product information and the chemical composition data to determine regulatory classifications and business logic classifications for the product; and
providing an output including one or more of the product information, the regulatory classifications, and the business logic classifications to a computing device.

10. The method of claim 9, further comprising:
receiving a safety data sheet (SDS) associated with the product;
determining difference data between data within the SDS and one or more of the product information, the regulatory classifications, and the business logic classifications; and
providing an alert including the difference data to a computing device.

11. The method of claim 9, further comprising:
generating a safety data sheet (SDS) for the product based on one or more of the product information, the regulatory classifications, and the business logic classifications; and
providing an alert including the SDS, the product information, the regulatory classifications, and the business logic classifications to a computing device.

12. The method of claim 9, wherein the plurality of logic expressions include one or more of a lookup, a Boolean expression, and a multi-variable if-then statement.

13. The method of claim 9, wherein the regulatory classifications comprise United States Department of Transportation codes and corresponding rules for transportation of the product on roads, on waterways, or through the air.

14. The method of claim 9, wherein the regulatory classifications comprise United States Environmental Protection Agency codes and corresponding rules for handling and disposal of the product.

15. The method of claim 9, wherein the business logic classification comprises one or more of:
guidelines for transportation of a product by land, air, or sea;
disposal of a product; recycling of a product;
donation of a product to a charity;
emergency response to an incident involving a product;
return of the product to a vendor;
packaging of a product; or
labeling of a product.

16. A system comprising:
a communications interface to communicate with a network;
a processor coupled to the communications interface; and
a memory to store data and to store processor-readable instructions, the processor-readable instructions to cause the processor to:
receive product information associated with a product;
determine fundamental attributes of the product based on the product information, the fundamental attributes including chemical composition data;
apply a plurality of logic expressions to the fundamental attributes to determine one or more regulatory classifications and one or more business logic classifications; and
provide data related to one or more of the product information, the regulatory classifications, and the business logic classifications to a computing device through the network.

17. The system of claim 16, wherein the processor-readable instructions cause the processor to:
determine a plurality of reliability values, each reliability value associated with a data item of one of the product data, the regulatory classifications, and the business logic classifications;
determine one of the plurality of reliability values is less than a threshold reliability; and
provide an alert indicative of the data item and a basis for the associated reliability value to a computing device..

18. The system of claim 16, wherein the processor-readable instructions cause the processor to:
receive a safety data sheet (SDS) associated with the product;
determine difference data between the SDS and one or more of the product data, the regulatory classifications, and the business logic classifications; and
provide an alert including the difference data to a computing device.

19. The system of claim 16, wherein the processor-readable instructions to cause the processor to:
automatically generate a safety data sheet (SDS) for the product based on one or more of the product data, the regulatory classifications, and the business logic classifications; and
provide an alert including the generated SDS to a computing device.

20. The system of claim 16, wherein the regulatory classifications comprise:
United States Department of Transportation codes and corresponding rules for transportation of the product on roads, on waterways, or through the air; and
the regulatory classifications comprise United States Environmental Protection Agency codes and corresponding rules for handling and disposal of the product.
